(19) United States
(12) Patent Application Publication
(10) Pub. No.: US 2008/0068583 A1
(43) Pub. Date: Mar. 20, 2008

(54) Signal processing circuit for optical encoder

(75) Inventor: Shuzo Hiraide, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 11/898,961

(22) Filed: Sep. 18, 2007

(30) Foreign Application Priority Data
Sep. 19, 2006 (JP) 2006-252259

(51) Int. Cl. G01C 3/08

(52) U.S. Cl. 356/4.01

(57) ABSTRACT

A signal processing circuit for optical encoder, including: a plurality of photodiodes for detecting light in different phase; IV conversion circuits for providing outputs by converting photo currents outputted from a current output terminal of each photodiode respectively into voltage signals; differential amplification circuits for amplifying difference between the output voltage signals corresponding to each photodiode; a DC signal detection circuit for detecting DC components of the photo currents; and a suppressing current generation circuit for supplying suppressing currents for suppressing the DC components to the current output terminals of the photodiodes in accordance with a value of the detected DC components.

This application claims benefit of Japanese Patent Application No. 2006-252259 filed in Japan on Sep. 19, 2006, the contents of which are incorporated by this reference.

### BACKGROUND OF THE INVENTION

The present invention relates to a signal processing circuit for optical encoder for detecting movement information such as an amount and direction of movement or angular displacement.

Among those having been developed as an optical encoder for detecting movement information such as an amount and direction of movement or angular displacement are: an optical path interrupting encoder in which a scale having slits at a certain interval thereon is moved so as to interrupt an optical path between a light source and a light receiving device so that light/dark of transmitted light is detected to obtain a position information; and a diffraction image projection encoder in which a light is radiated on a scale from a light source and a movement of light/dark of diffraction interference pattern by the reflected light is detected at a light receiving section to obtain a position information.

As a prior-art example of such encoder, a general plane view and side view of a diffraction image projection encoder disclosed in Japanese Patent Application Laid-Open 2000-205819 are shown in FIGS. 1A and 1B. What is denoted by 301 in FIGS. 1A and 1B is a light source. A light emitted from the light source 301 is radiated on a reflecting-type diffraction grating scale 302 where stripes of light/dark are alternately placed. The diffraction image projection encoder is constructed so that a specific portion of thus produced diffraction interference pattern is detected at an optical detector 304 disposed in parallel to the scale 302 with having a plurality of light receiving areas 303. A photodiode for example is used for the light receiving area 303 as a means for detecting signal intensity.

Referring to FIGS. 1A and 1B: z1 represents the distance between the light source 301 and the plane in which the diffraction grating on the scale 302 is formed; z2, distance between the plane in which the diffraction grating on the scale 302 is formed and the light receiving plane of the optical detector 304; p1, pitch of the diffraction grating on the scale 302; and p2, pitch of diffraction interference pattern on the light receiving plane of the optical detector 304. It should be noted that, hereinafter, “pitch of diffraction grating on the scale” refers to a spatial period of pattern where optical characteristics formed on the scale 302 are modulated. Further, “pitch of diffraction interference pattern on the light receiving plane of the optical detector” refers to a spatial period of intensity distribution of diffraction interference pattern produced on the light receiving plane of the optical detector 304.

An operation of the diffraction image projection encoder constructed as the above will now be described. According to the diffraction theory of light, when a specific relationship between the above described distances z1, z2 exists so as to satisfy the expression of (1), an intensity pattern similar to the diffraction grating pattern on the scale 302 is produced on the light receiving plane of the optical detector 304.

1/z1+1/z2=λ/k(p1)² (1)

where λ is the wavelength of light beam radiated from the light source 301, and k is an integer. Given expression (1), pitch p2 of the diffraction interference pattern in the light receiving plane is expressed as in the expression (2) using other constituent parameters.

p2=p1(z1+z2)/z1 (2)

When the scale 302 is displaced in the direction of pitch of the diffraction grating in relation to the light source 301, the distribution intensity of the diffraction interference pattern is moved in the direction of displacement of the scale 302 with keeping the same spatial period. Accordingly, if a spatial period p20 of the light receiving area 303 of the optical detector 304 is set to the same value as the diffraction interference pattern p2 in the light receiving plane, a periodical signal intensity is obtained from the optical detector 304 every time when the scale 302 is moved by p1 in the pitch direction. A displacement amount in the pitch direction of the scale 302 is thereby detected. In other words, an output signal that changes by a periodical intensity is obtained from the optical detector 304 every time when the scale 302 is displaced by 1 pitch in the direction of pitch of the diffraction grating.

FIG. 2 shows a plan in the case where the light receiving plane of the optical detector 304 of the prior-art example is seen from the side of the scale 302. In FIG. 2, what is denoted by 304 is the optical detector. On the optical detector 304, there are four light receiving area groups, each consisting of a plurality (3 in the illustrated example) of light receiving areas 303 formed at an interval of p20 which is expressed as p20=np1(z1+z2)/z1 (n being a natural number). The plurality of light receiving areas of each of these groups alternate with the others in a manner shifted from one another by a spatial position shift δ p20 of each group. It should be noted that the spatial position shift δ p20 is set to an odd-number multiple of ¼ of the diffraction interference pattern p2 in the light receiving plane. Each light receiving area of the 4-group construction is connected respectively through a wiring to output pads 305A, 305A′, 305B, and 305B′.

An operation of the optical detector of the prior-art example having such construction will now be described. Referring to FIG. 2, since the spatial position shift of each light receiving area group is set to an odd-number multiple of (p2×¼), signals with phase shifted by ¼ period from one another or A phase, B phase, inverted-A phase, and inverted-B phase of a so-called encoder signal are outputted from the respective pads 305A, 305A′, 305B, and 305B′. Since the signals of A phase and inverted-A phase, and of B phase and inverted-B phase respectively have an inverted phase relationship with each other, an encoder signal can be obtained by taking a difference signal between A phase and inverted-A phase, and a difference signal between B phase and inverted-B phase.

### SUMMARY OF THE INVENTION

In a first aspect of the invention, there is provided a signal processing circuit for optical encoder, including: a plurality of photodiodes for detecting light in different phase; IV conversion circuits for providing outputs by converting photo currents outputted from a current output terminal of each photodiode respectively into voltage signals; differential amplification circuits for amplifying difference between the output voltage signals corresponding to each photodiode; a DC signal detection circuit for detecting DC components of the photo currents; and a suppressing current generation circuit for supplying suppressing currents for suppressing the DC components to the current output terminals of the photodiodes in accordance with a value of the detected DC components.

In a second aspect of the invention, the DC signal detection circuit in the signal processing circuit for optical encoder according to the first aspect receives as input the output voltage signals corresponding to each photodiode and outputs DC components of the photo currents as DC voltage signal, and the suppressing current generation circuit includes a DC signal monitoring circuit for monitoring the DC voltage signal, a VI conversion circuit for converting the DC voltage signal into a current value corresponding to result of the monitoring so as to output it as the suppressing current, and a current mirror circuit for copying the suppressing current and supplying it to the current output terminals of each photodiode.

In a third aspect of the invention, the VI conversion circuit in the signal processing circuit for optical encoder according to the second aspect includes a gain regulating amplifier for regulating gain of the DC voltage signal in accordance with result of the monitoring, a resistor, an operational amplifier for applying the DC voltage signal regulated of gain to the resistor, and a transistor for controlling electric current flowing through the resistor. The gain-regulated DC voltage signal is converted into a current value so as to be outputted as the suppressing current.

In a fourth aspect of the invention, the VI conversion circuit in the signal processing circuit for optical encoder according to the second aspect includes a variable resistor capable of changing resistance value thereof in accordance with result of the monitoring, an operational amplifier for applying the DC voltage signal to the variable resistor, and a transistor for controlling electric current flowing through the variable resistor. The DC voltage signal is converted into a current value corresponding to the resistance value of the variable resistor so as to be outputted as the suppressing current.

### BRIEF DESCRIPTION OF THE DRAWINGS

FIGS. 1A and 1B are a plane view and side view showing construction of a prior-art diffraction image projection encoder.

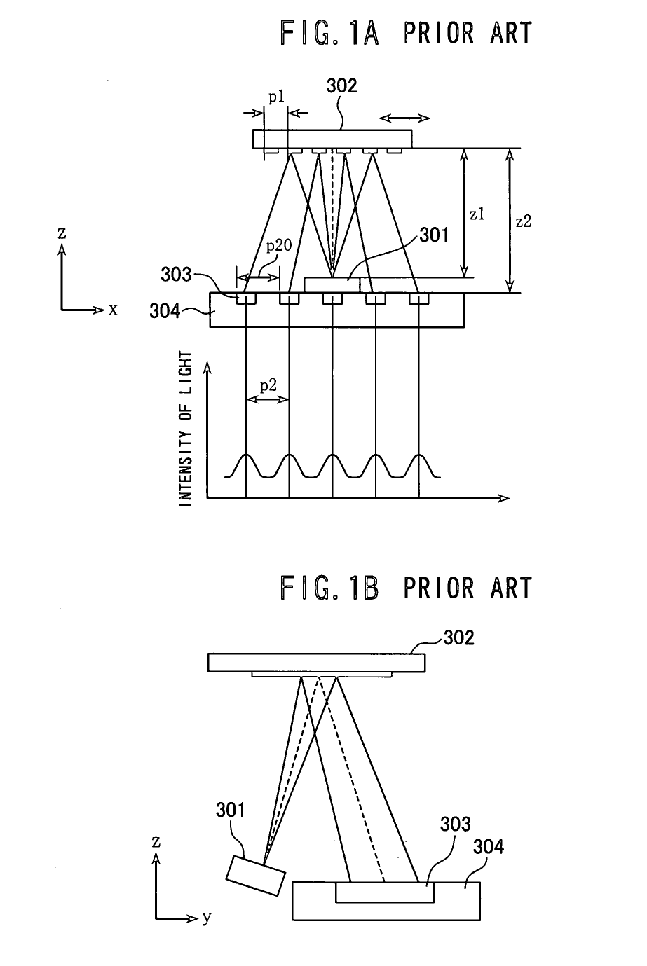

FIG. 2 is a plan where a light receiving surface of the optical detector in the diffraction image projection encoder shown in FIGS. 1A and 1B is seen from the side of the scale.

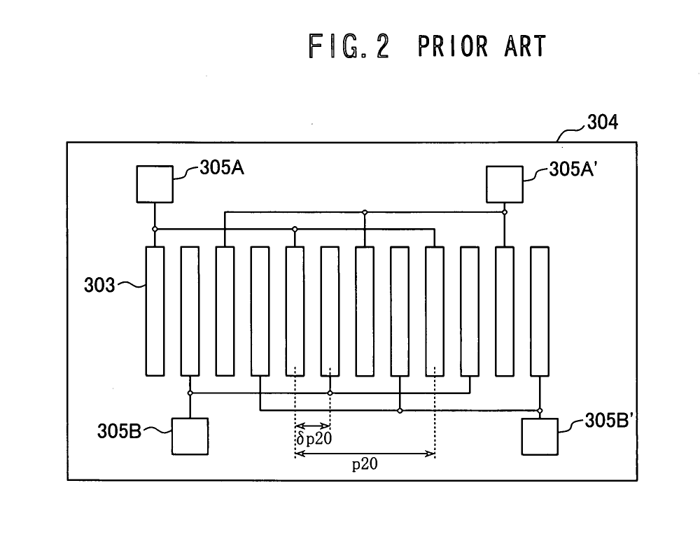

FIG. 3 is a circuit diagram showing construction of a first embodiment of the signal processing circuit for optical encoder according to the invention.

FIG. 4 is a circuit diagram showing construction of the signal processing circuit for optical encoder according to a second embodiment of the invention.

### DESCRIPTION OF THE PREFERRED EMBODIMENTS

A description will now be given by way of the drawings with respect to some embodiments of the signal processing circuit for optical encoder according to the invention.

### Embodiment 1

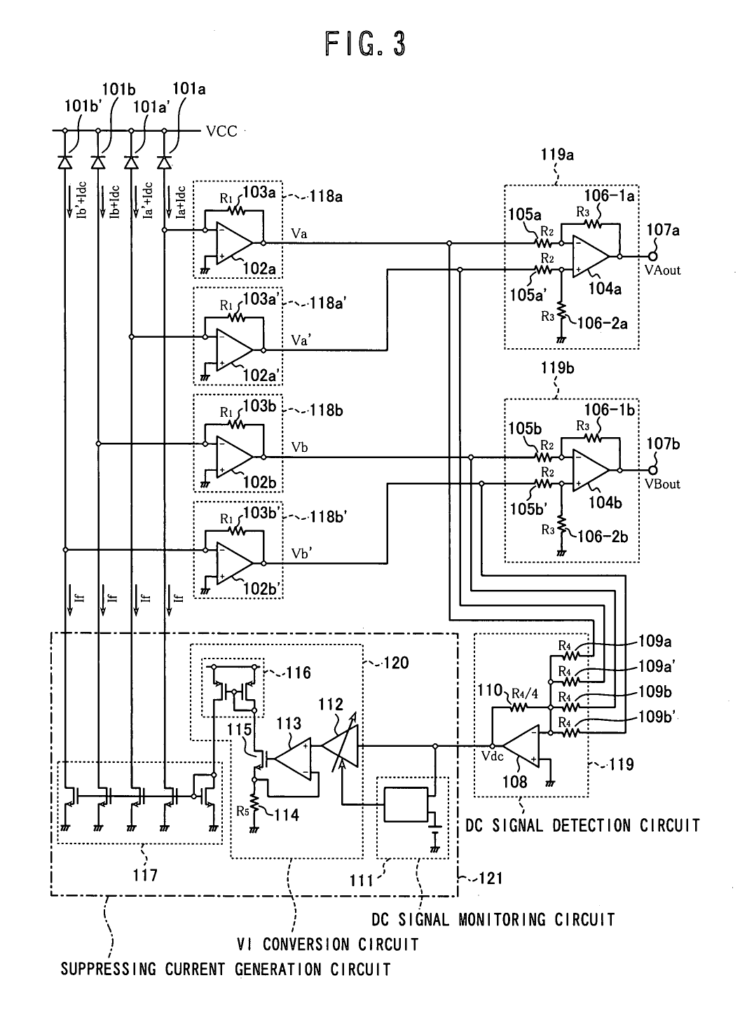

A first embodiment of the signal processing circuit for optical encoder according to the invention will now be described. FIG. 3 is a circuit diagram showing construction of the signal processing circuit for optical encoder according to the first embodiment. Referring to FIG. 3, 101a, 101a′, 101b, and 101b′ each are a photodiode for converting optical signal into an electric current signal, each cathode terminal of the photodiode group being connected to a power supply voltage VCC. Further, the anode terminals thereof are respectively connected to inverting input terminals of operational amplifiers 102a, 102a′, 102b, 102b′ of which the respective non-inverting input terminals are connected to a reference potential (ground potential). Resistors 103a, 103a′, 103b, and 103b′ each having a resistance value R₁ are connected between the inverting input terminal and the output terminal of the operational amplifiers 102a, 102a′, 102b, and 102b′.

An output of the operational amplifier 102a is connected to one terminal of a resistor 105a having a resistance value R₂ of which the other terminal is connected to an inverting input terminal of an operational amplifier 104a. An output of the operational amplifier 102a′ is connected to one terminal of a resistor 105a′ having a resistance value R₂ of which the other terminal is connected to a non-inverting input terminal of the operational amplifier 104a. It should be noted that a resistor 106-1a having a resistance value R₃ is connected between the inverting input terminal and the output terminal of the operational amplifier 104a while a resistor 106-2a having a resistance value R₃ is connected between the non-inverting input terminal and the reference potential (ground potential), and the output terminal of the operational amplifier 104a is connected to an encoder signal output terminal 107a.

Further, an output of the operational amplifier 102b is connected to one terminal of a resistor 105b having a resistance value R₂ of which the other terminal is connected to an inverting input terminal of an operational amplifier 104b. An output of the operational amplifier 102b′ is connected to one terminal of a resistor 105b′ having a resistance value R₂ of which the other terminal is connected to a non-inverting input terminal of the operational amplifier 104b. It should be noted that a resistor 106-1b having a resistance value R₃ is connected between the inverting input terminal and the output terminal of the operational amplifier 104b while a resistor 106-2b having a resistance value R₃ is connected between the non-inverting input terminal and the reference potential (ground potential), and the output terminal of the operational amplifier 104b is connected to an encoder signal output terminal 107b.

Further, the outputs of the operational amplifiers 102a, 102a′, 102b, and 102b′ are respectively connected to one terminal of resistors 109a, 109a′, 109b, and 109b′ each having a resistance value R₄ of which the other terminal are connected to an inverting input terminal of an operational amplifier 108. A non-inverting input terminal of the operational amplifier 108 is connected to a reference potential (ground potential), and a resister 110 having a resistance value R₄/4 is connected between the inverting input terminal and the output terminal thereof.

An output terminal of the operational amplifier 108 is connected to a DC signal monitoring circuit 111 and to a gain regulating amplifier 112, and an output of the DC signal monitoring circuit 111 is transmitted as control signal to the gain regulating amplifier 112. The DC signal monitoring circuit 111 is composed of a differential amplifier where DC voltage signal from the operational amplifier 108 is compared with a target reference DC voltage to generate a difference signal. Such difference signal is transmitted as control signal to the gain regulating amplifier 112. An output of the gain regulating amplifier 112 is connected to a non-inverting input terminal of the operational amplifier 113, and an inverting input terminal of the operational amplifier 113 is connected to one terminal of a resistor 114 having a resistance value R₅ of which the other terminal is connected to a reference potential (ground potential). An output of the operational amplifier 113 is connected to the gate terminal of a transistor 115 of which the source terminal is connected to the inverting input terminal of the operational amplifier 113.

The drain terminal of the transistor 115 is connected to an input terminal of a current mirror circuit 116, and an output terminal of the current mirror circuit 116 is connected to an input terminal of a current mirror circuit 117 which has four output terminals. Each output terminal of the current mirror circuit 117 is respectively connected to the anode terminal of the photodiodes 101a, 101a′, 101b, and 101b′.

The operational amplifier 102a and resistor 103a, the operational amplifier 102a′ and resistor 103a′, the operational amplifier 102b and resistor 103b, and the operational amplifier 102b′ and resistor 103b′ respectively constitute IV conversion circuits 118a, 118a′, 118b, and 118b′ at which photo current signals outputted from photodiodes 101a, 101a′, 101b, and 101b′ are respectively converted into voltage signals to be outputted. The operational amplifier 104a, resistors 105a, 105a′, 106-1a, and 106-2a constitute a differential amplification circuit 119a which obtains and amplifies the differential signal between the respective output voltage signals of the IV conversion circuits 118a and 118a′. The operational amplifier 104b, and resistors 105b, 105b′, 106-1b, and 106-2b constitute a differential amplification circuit 119b which obtains and amplifies the differential signal between the respective output voltage signals of the IV conversion circuits 118b and 118b′.

The operational amplifier 108, resistors 109a, 109a′, 109b, and 109b′, and resistor 110 constitute a DC signal detection circuit 119 which adds up the output voltage signals of the respective IV conversion circuits 118a, 118a′, 118b, and 118b′ to detect DC component of the optical signals. The gain regulating amplifier 112, operational amplifier 113, resistor 114, transistor 115, and current mirror circuit 116 constitute a VI conversion circuit 120 which converts DC voltage signal into a current value and outputs it as a suppressing current. The DC signal monitoring circuit 111, VI conversion circuit 120, and current mirror circuit 117 constitute a suppressing current generation circuit 121 which supplies the suppressing current for suppressing the DC component to anode terminals that are the photo current output terminals of the photodiodes 101a, 101a′, 101b, and 101b′ in accordance with the value of the DC component.

An operation will now be described of thus constructed signal processing circuit for optical encoder according to the first embodiment. From the photodiodes 101a, 101a′, 101b, and 101b′ in FIG. 3, photo currents are respectively detected with a shift in phase respectively of ½ period between the photodiodes 101a and 101a′, ½ period between the photodiodes 101b and 101b′, ¼ period between the photodiodes 101a and 101b, and ¼ period between the photodiodes 101a′ and 1101b′. The photo currents respectively detected at each of the photodiodes, after subtraction of the suppressing current If produced by the suppressing current generation circuit 121, is inputted respectively to the IV conversion circuits 118a, 118a′, 118b, and 118b′ that correspond to each photodiode.

Here, supposing Ia, Ia′, Ib, and Ib′ as AC current components of photo current generated by difference in light/dark of the lights incident respectively on the photodiodes 101a, 101a′, 101b, and 101b′, and Idc as DC current component generated by dark current and the continuously incident light or in other words a background light, the voltage signals Va, Va′, Vb, and Vb′ outputted from each IV conversion circuit 118a, 118a′, 118b, and 118b′ are respectively expressed by the expressions (3) to (6).

Va=−R₁ (Ia+Idc−If) (3)

Va′=−R₁(Ia′+Idc−If) (4)

Vb=−R₁(Ib+Idc−If) (5)

Vb′=−R₁(Ib′+Idc−If) (6)

Next, the voltage signals Va and Va′ outputted from the IV conversion circuits 118a, 118a′ are inputted to the differential amplification circuit 119a, and the voltage signals Vb and Vb′ outputted from the IV conversion circuits 118b, 118b′ are similarly inputted to the differential amplification circuit 119b so that these are respectively differentiated and amplified. The signals operated and amplified at each of the differential amplification circuits 119a, 119b are respectively outputted to the encoder signal output terminals 107a and 107b. The encoder signals VAout, VBout to be outputted to the respective encoder signal output terminals 107a, 107b are obtained by the following expressions (7), (8).

$$\begin{matrix}\begin{matrix}VAout = {R}_{3} / {R}_{2} \cdot ( {Va}^{′} - Va ) \\ = {R}_{3} / {R}_{2} \cdot \{ - {R}_{1} ( {Ia}^{′} + Idc - If ) + {R}_{1} ( Ia + Idc + If ) \} \\ = {R}_{1} {R}_{3} / {R}_{2} \cdot ( Ia - {Ia}^{′} )\end{matrix} & ( 7 ) \\ \begin{matrix}VBout = {R}_{3} / {R}_{2} \cdot ( {Vb}^{′} - Vb ) \\ = {R}_{3} / {R}_{2} \cdot \{ - {R}_{1} ( {Ib}^{′} + Idc - If ) + {R}_{1} ( Ib + Idc - If ) \} \\ = {R}_{1} {R}_{3} / {R}_{2} \cdot ( Ib - {Ib}^{′} )\end{matrix} & ( 8 )\end{matrix}$$

where Ia=−Ia′, Ib=−Ib′, since Ia and Ia′, and Ib and Ib′ are the signals shifted in phase by ½ period from each other. The expressions (7), (8) thus become the following expressions (9), (10) so that encoder signals VAout and VBout having a phase difference of ¼ period are generated.

VAout=2R₁R₃/R₂·Ia (9)

VBout=2R₁R₃/R₂·Ib (10)

Now, the output voltage signals Va, Va′, Vb, Vb′ of the IV conversion circuits 118a, 118a′, 118b, 118b′ are inputted to the DC signal detection circuit 119 so as to be operated. Since the DC signal detection circuit 119 is formed as a summing amplifier having an input resistance R₄ and feedback resistance R₄/4, the following expression (11) where Vdc is output voltage is obtained from the expressions (3) to (6).

$$\begin{matrix}Vdc = - ( {R}_{4} / 4 ) / {R}_{4} \cdot ( Va + {Va}^{′} + Vb + {Vb}^{′} ) \\ = {R}_{1} / 4 \cdot \{ ( Ia + {Ia}^{′} + Ib + {Ib}^{′} ) + 4 ( Idc - If ) \}\end{matrix} \qquad ( 11 )$$

Here, of the AC components of each photo current, there is a shift in phase of ½ period from each other between 1a and 1a′, and between 1b and 1b′. Accordingly, the following expression (12) is obtained.

Ia+Ia′+Ib+Ib′=0 (12)

### From (12), thus, (11) is expressed by the following expression (13)

Vdc=R₁(Idc−If) (13)

As can be seen from the above expression (13), in consequence, the DC signal detection circuit 119 is to detect DC component of the signals flowing out from the photodiodes.

Next, the DC voltage signal Vdc detected at the DC signal detection circuit 119 is inputted to the suppressing current generation circuit 121. At the suppressing current generation circuit 121, the DC voltage signal Vdc is inputted to the DC signal monitoring circuit 111 and to the gain regulating amplifier 112 of the VI conversion circuit 120 so that it is amplified by the gain regulating amplifier 112 under control of the DC signal monitoring circuit 111. Supposing the gain as α and output voltage of the gain regulating amplifier 112 as VG, the output voltage VG of the gain regulating amplifier 112 is obtained by the following expression (14).

VG=α Vdc=α R₁(Idc−If) (14)

The DC voltage signal multiplied by α is converted into the suppressing current If as shown in the following expression (15) by the VI conversion circuit 120.

If=VG/R₅=α·R₁/R₅·(Idc−If) (15)

Rearranging (15), the following expression (16) is obtained.

If{α/(R₅/R₁+α)}·Idc (16)

where, especially when R1=R5 is put, the suppressing current If is represented by the following expression (17).

If=α/(1+α)·Idc (17)

The suppressing current If, which is an output current of the VI conversion circuit 120, is copied by the current mirror circuit 117, and is supplied to the anode terminals of the photodiodes 101a, 101a′, 101b, and 101b′ as an output of the suppressing current generation circuit 121. From (3) to (6), and (17) of the above, thus, the voltage signals Va, Va′, Vb, and Vb′ outputted from the IV conversion circuits 118a, 118a′, 118b, and 118b′ are respectively represented by the following expressions (18) to (21).

Va=−R₁Ia−R₁/(1+α)·Idc (18)

Va′=−R₁Ia′−R₁/(1+α)·Idc (19)

Vb=−R₁Ib−R₁/(1+α)·Idc (20)

Vb′=−R₁Ib′−R₁/(1+α)·Idc (21)

Further, from (13) and (16), the DC voltage signal Vdc is obtained as in the following expression (22).

Vdc=R₁/(1+α)·Idc (22)

In the first embodiment as the above, the DC voltage signal Vdc, which is an output voltage of the DC signal detection circuit 119, is monitored by comparing it with the reference DC voltage provided at the DC signal monitoring circuit 111. If the DC voltage signal Vdc is greater than the reference voltage DC, i.e., the DC component of photo current is large, the gain α at the gain regulating amplifier 112 is made higher by control of the DC signal monitoring circuit 111 to increase the suppressing current If. If, on the other hand, the DC voltage signal Vdc is smaller, i.e., the DC component of photo current is small, the gain α of the gain regulating amplifier 112 is lowered to decrease the suppressing current If. In this manner, even when DC component of the photo current photoelectrically converted at the photodiode is large, distortion of the output voltage of the IV conversion circuit is avoided so that the IV conversion circuit can be operated in an optimum operation range. Accordingly, stable and accurate signal processing of optical encoder can be effected.

### Embodiment 2

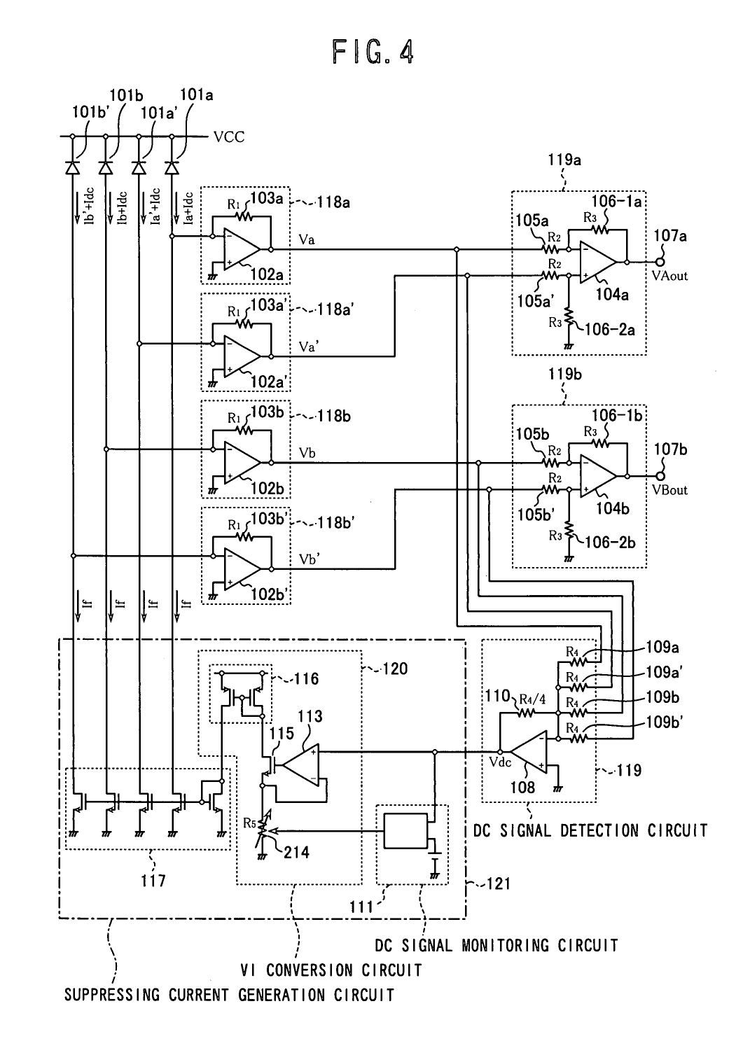

A description will now be given by way of FIG. 4 with respect to a second embodiment of the signal processing circuit for optical encoder according to the invention. The main differences from the first embodiment shown in FIG. 3 will be described below with partially omitting a description of the common portions. First, construction of the signal processing circuit for optical encoder according to the second embodiment will be described. Referring to FIG. 4, what is denoted by 119 is a DC signal detection circuit identical to that of the first embodiment. An output of the DC signal detection circuit 119 is connected to an input of the DC signal monitoring circuit 111 and to an input of the VI conversion circuit 120. A variable resistor constitutes a resistor 214 having one terminal connected to a reference potential (ground potential) and the other terminal to an inverting input terminal of the operational amplifier 113 and to a source terminal of transistor 115, and resistance value R₅ of the variable resistor 214 is controlled by output signal of the DC signal monitoring circuit 111.

An operation of thus constructed second embodiment will now be described. Similarly to the first embodiment, the DC voltage signal Vdc detected at the DC signal detection circuit 119 is inputted to the suppressing current generation circuit 121. At the suppressing current generation circuit 121, the DC voltage signal Vdc is inputted to the DC signal monitoring circuit 111 and to the VI conversion circuit 120. The DC voltage signal Vdc is then converted into the suppressing current If as in the following expression (23) by the VI conversion circuit 120 which has the variable resistor 214 where the resistance value R₅ is changed by control of the DC signal monitoring circuit 111.

If=Vdc/R₅=R₁/R₅·(Idc−If) (23)

Rearranging (23), the following expression (24) is obtained.

If=R₁/(R₅+R₁)·Idc (24)

The suppressing current If, which is an output current of the VI conversion circuit 120, is copied by the current mirror circuit 117 and is supplied to the anode terminals of the photodiodes 101a, 101a′, 101b, and 101b′ as output of the suppressing current generation circuit 121. From (3) to (6), and (24) of the above, thus, the voltage signals Va, Va′, Vb, and Vb′ outputted from the IV conversion circuits 118a, 118a′, 118b, and 118b′ are respectively represented by the following expressions (25) to (28).

Va=−R₁Ia−R₁R₅/(R₅+R₁)·Idc (25)

Va′=−R₁Ia′−R₁R₅/(R₅+R₁)·Idc (26)

Vb=−R₁Ib−R₁R₅/(R₅+R₁)·Idc (27)

Vb′=−R₁Ib′−R₁R₅/(R₅+R₁)·Idc (28)

Further, from (13) and (24), the DC voltage signal Vdc is represented by the following expression (29).

Vdc=R₁R₅/(R₅+R₁)·Idc (29)

In the second embodiment as the above, the DC voltage signal Vdc, which is an output voltage of the DC signal detection circuit 119, is monitored by the DC signal monitoring circuit 111 similarly to the first embodiment. If the DC voltage signal Vdc is large, i.e., the DC component of photo current is large, the resistance value of the variable resistor 214 of the VI conversion circuit 120 is set to a smaller value under instruction from the DC signal monitoring circuit 111 to increase the suppressing current If. If, on the other hand, the DC voltage signal Vdc is small, i.e., the DC component of photo current is small, the resistance value of the variable resistor 214 is set to a larger value to decrease the suppressing current If. In this manner, even when DC component of the photo current photoelectrically converted at the photodiode is large, distortion of the output voltage of the IV conversion circuit is avoided so that the IV conversion circuit can be operated in an optimum operation range. Accordingly, a stable and accurate signal processing of optical encoder can be effected.

As has been described by way of the above embodiments, according to the first and second aspects of the invention, DC component of photo currents is detected at the DC signal detection circuit, and, if the DC component of the photo currents is small, a suppressing current from the suppressing current generation circuit for suppressing DC component is made smaller, while the suppressing current for suppressing DC component is increased when DC component of the photo currents is large. Failure of the output voltage of the IV conversion circuit by the amount of photo currents is thereby avoided and the IV conversion circuit can be operated in an optimal operation range so that the signal processing for optical encoder can be effected in a stable manner.

According to the third aspect, an output voltage of the DC signal detection circuit is monitored by the DC signal monitoring circuit, and, if the output voltage is small, i.e., DC component of the photo currents is small, the gain of the gain regulating amplifier is lowered to make the suppressing current smaller, while the gain of the gain regulating amplifier is made higher to increase the suppressing current when the DC component of the photo currents is large. Failure of the output voltage of the IV conversion circuit by the amount of photo currents is thereby avoided and the IV conversion circuit can be operated in an optimal operation range so that the signal processing for optical encoder can be effected in a stable manner.

According to the fourth aspect, an output voltage of the DC signal detection circuit is monitored by the DC signal monitoring circuit, and, if the output voltage thereof is small, i.e., DC component of the photo currents is small, the resistance value of a variable resistor of VI amplifier is set to a higher level under an instruction from the DC signal monitoring circuit to make the suppressing current smaller, while the resistance value of the variable resistor is set to a lower value to increase the suppressing current when the output voltage is high, i.e., DC component of the photo currents is large. Failure of the output voltage of the IV conversion circuit by the amount of photo currents is thereby avoided and the IV conversion circuit can be operated in an optimal operation range so that the signal processing for optical encoder can be effected in a stable manner.

What is claimed is:

1. A signal processing circuit for optical encoder, comprising:
a plurality of photodiodes for detecting light in different phase;
IV conversion circuits for providing outputs by converting photo currents outputted from a current output terminal of each photodiode respectively into voltage signals;
differential amplification circuits for amplifying difference between said output voltage signals corresponding to each photodiode;
a DC signal detection circuit for detecting DC components of said photo currents; and
a suppressing current generation circuit for supplying suppressing currents for suppressing said DC components to the current output terminals of said photodiodes in accordance with a value of said detected DC components.

2. The signal processing circuit for optical encoder according to claim 1, wherein said DC signal detection circuit receives as input said output voltage signals corresponding to each photodiode and outputs DC components of said photo currents as DC voltage signal, and
wherein said suppressing current generation circuit comprises a DC signal monitoring circuit for monitoring said DC voltage signal, a VI conversion circuit for converting said DC voltage signal into a current value corresponding to result of said monitoring so as to output it as said suppressing current, and a current mirror circuit for copying said suppressing current and supplying it to said current output terminals of each photodiode.

3. The signal processing circuit for optical encoder according to claim 2, wherein said VI conversion circuit comprises a gain regulating amplifier for regulating gain of said DC voltage signal in accordance with result of said monitoring, a resistor, an operational amplifier for applying said DC voltage signal regulated of gain to said resistor, and a transistor for controlling electric current flowing through said resistor, and wherein said gain-regulated DC voltage signal is converted into a current value so as to be outputted as said suppressing current.

4. The signal processing circuit for optical encoder according to claim 2, wherein said VI conversion circuit comprises a variable resistor capable of changing resistance value thereof in accordance with result of said monitoring, an operational amplifier for applying said DC voltage signal to said variable resistor, and a transistor for controlling electric current flowing through said variable resistor, and wherein said DC voltage signal is converted into a current value corresponding to the resistance value of said variable resistor so as to be outputted as said suppressing current.
